(19) United States
(12) Patent Application Publication
(10) Pub. No.: US 2024/0190257 A1
(43) Pub. Date: Jun. 13, 2024

(54) ELECTRIC REGENERATION UNIT FOR TRUCK TRAILER

(71) Applicant: ZEVX Inc., Gilbert, AZ (US)

(72) Inventors: Charlie Maury, Mesa, AZ (US); Damon Kuhn, Needville, TX (US); James Maury, Mesa, AZ (US)

(21) Appl. No.: 18/383,983

(22) Filed: Oct. 26, 2023

Related U.S. Application Data
(60) Provisional application No. 63/475,248, filed on Oct. 26, 2022.
(60) Provisional application No. 63/475,249, filed on Oct. 26, 2022.
(60) Provisional application No. 63/475,247, filed on Oct. 26, 2022.

(51) Int. Cl. B60L 8/00

(52) U.S. Cl. CPC B60L 8/006; B60L 8/003; B60L 2200/28

(57) ABSTRACT

An electric regeneration unit for a truck trailer is disclosed. The electric regeneration unit includes a venturi generator unit having an inlet with an inlet axis and an outlet with an outlet axis oriented transversely to the inlet axis. A housing, containing the venturi generator unit, is adapted for mounting the inlet to a forward facing surface of the trailer and the outlet to a side facing surface of the trailer.

### CROSS-REFERENCE TO RELATED APPLICATION

This application claims the benefit of and priority to U.S. Provisional Patent Application Ser. No. 63/475,248, filed on Oct. 26, 2022, to U.S. Provisional Patent Application Ser. No. 63/475,249, filed on Oct. 26, 2022, and to U.S. Provisional Patent Application Ser. No. 63/475,247, filed on Oct. 26, 2022, the contents of each of which are hereby incorporated by reference in its entirety.

### TECHNICAL FIELD

The present invention relates generally to the field of electrical power generation within a towed commercial trailer. More specifically, the invention relates to improving the recapture of energy lost to aerodynamic drag during towing of the trailer.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

There have been many prior approaches to capturing energy associated with moving motor vehicles, but thus far, improvements have continued without approaching any theoretically optimized solution. Examples of prior approaches directed to the capture of energy associated with moving vehicles are dominated by systems having roof mounted fans exposed to the air passing over the roof. These systems all suffer from the fact that they add extra aerodynamic drag to the vehicle due to their frontal surface area being exposed to the flow of air.

Towed trailers present a distinct challenge, particularly related to the very substantial aerodynamic drag associated with moving a large box at high speeds through the air. Prior attempts to address this drag have been directed to improving the shape of the trailer and the provision of a rooftop deflector on the towing vehicle. Each of these helps, but there is still a substantial inefficiency associated with towing a large box-like trailer.

Examples of other systems for recovering some of the energy otherwise lost to aerodynamic drag include the following. U.S. Pat. No. 10,669,992, dated Jun. 2, 2020, “Wind power collection and electricity generation system” describes a technique for collecting the wind energy created by moving motor vehicles. This patent recognizes that energy is available as a result of the movement of a vehicle through the air but directs the collected energy to a central location instead of making the captured energy available to the individual driven vehicle. Thus, the captured energy is not useful for the driven vehicle, such as for extending the range of a vehicle being driven.

U.S. Pat. No. 10,533,536, dated Jan. 14, 2020, “Wind power generating device installed in a vehicle” describes a wind power arrangement installed on a vehicle and intended to provide a continuing supply of electrical energy, even when the vehicle is not moving.

U.S. Pat. No. 10,479,197, dated Nov. 19, 2019, “Wind powered system for vehicles” discloses another wind powered system which includes “a plurality of wind tunnels, a plurality of rotary fans provided in each wind tunnel, a plurality of alternators connected to the plurality of rotary fans to generate electricity, a transformer connected to the plurality of alternators, electric components connected to the transformer, and a battery connected to the transformer and the electric components. The transformer is supplied with the electricity generated by the alternators and outputs electrical energy with a voltage to be supplied to at least one of the electric components and the battery. The plurality of wind tunnels have a plurality of intake inlets which are separated and apart from each other and a single outlet shared by the plurality of wind tunnels.”

U.S. Pat. No. 10,173,663, dated Jan. 8, 2019, “Total electric vehicle”, discloses a system wherein an electric vehicle receives propulsion power from “two sources of static, stored, electric power and three sources of Dynamic, generated electric power. The two stored sources are a Battery and a supercapacitor system. The three sources of Dynamic power are: (1) Regenerative power in both the braking, deceleration phase of travel, the downward slope of travel over some extended distance, and part of cruise control; (2) Power from a modified Squirrel Cage generator; and (3) Power through the solar silicon panels. The Static and Dynamic powers are fed into the current Consolidator, Distributer, and Controller (CDC) systems to provide electric power to the drive motors. The total distance travelled is the sum of the Static, stored power plus the generated power of the Dynamic system.”

Still, even with all the work that has been done, it has been recognized that further improvements are necessary. This is made clear in U.S. Pat. No. 10,072,641, dated Sep. 11, 2018, “Apparatus for generating energy from a fluid flow induced movement of a surface structure relative to an opening to a cavity in a frame” that discloses another approach to capturing wind energy in a moving vehicle. This disclosure identifies limitations in the prior art, stating, for instance, that “Generators harnessing energy from a fluid flow (such as air) are known within the art, however such generators typically have turbines or propellers which have a large cross-section. The movement of the medium creates a motive force upon the turbine or propeller, which is connected to a device to convert the movement into electricity. But the large cross-sections of these traditional designs increase the amount of wind resistance presented by the generators, limiting the practicality of their application in certain fields.” This patent further states, “There is a need for a device that can generate electricity from relatively lower levels of motive force and provide smaller cross-sections. There is also a need for scalable, stackable devices to generate electricity in locations where traditional devices are not suitable. The increased use of electric and hybrid engine systems in vehicles has also created an increased need for ways of generating electricity to recharge batteries.”

In other instances of capture of wind energy for electrical power generation, it is ordinary practice to place a windmill, to the extent possible, away from any interfering structures. Thus, windmill farms are placed in wide open spaces, such as flat fields or offshore, where there is no interruption of the incoming wind flow. Similarly, even for sailboats, it is common to place a windmill-type structure on a separate mast. These approaches are not suitable for introduction to a moving vehicle due to the substantial turbulence introduced by the moving vehicle.

Overcoming the above-mentioned drawbacks of the prior art would be desirable.

### SUMMARY

According to the invention, energy from the apparent wind can be harnessed in a moving trailer in an efficient manner relative to pre-existing approaches. This is accomplished by providing a system in which wind powered generation devices are positioned at locations on the vehicle where there is high air pressure resulting, for the most part, from forward facing portions of the vehicle impacting the air as the vehicle progresses. At these locations, wind energy is concentrated and can be captured efficiently by a wind-based generator while at the same time avoiding the creation of significant incremental aerodynamic drag in the vehicle. By directing this energy to the onboard vehicle energy requirements there is a net improvement in the trailer's ultimate net consumption of energy. These high pressure areas have high potential energy relative to areas where the wind flows more efficiently along the vehicle surfaces. Identification of these areas can be accomplished according to the invention and the wind-based generators can be strategically placed to take advantage of aerodynamic inefficiencies associated with vehicle design. The invention is particularly adapted for improving the power efficiency of existing trailers by retrofitting the power generation devices into existing trailers and thereby reducing the requirements for battery-stored energy.

It is an object of the present invention to improve the energy efficiency of a towed trailer by recapturing some of the energy otherwise lost to aerodynamic drag.

It is another object of the present invention to capture the greatest amount of wind energy possible relative to the amount of wind resistance added to a moving trailer on which the wind generation system is mounted. In this manner, the system captures energy that would otherwise be wasted.

It is another object of the present invention to provide a wind generation system that can be used in a towed trailer without unnecessarily increasing the aerodynamic drag of the trailer, and in which any increases in aerodynamic drag are more than offset by the energy generated by the system.

It is another object of the invention to provide an arrangement that ventilates the cargo hold of the trailer without requiring additional expenditure of energy for the ventilation.

These and other objectives of the invention are accomplished through a combination of highly efficient device design and highly sophisticated analysis of the overall trailer arrangement. These design and analysis components of the implementations of the invention call for identifying specific areas on the trailer where wind forces are relatively high, yet where the forces can be harnessed without creating an undesirable offsetting incremental counterforce. In towed trailers any added drag to the trailer's aerodynamic performance is of major commercial importance. Thus, the invention facilitates capture of the wind forces for electrical power generation without adding an incremental equal and opposite reaction. This is done by locating regions of the trailer structure where wind forces already impede the forward movement of the trailer through the air and harnessing a substantial portion of the existing energy loss for electrical power generation. Importantly, the invention also calls for the avoidance of placing wind energy recapture devices at locations where the incremental aerodynamic drag exceeds the energy that can be recaptured. These advantages are further enhanced by placing the outlets of the energy recapture devices at locations on the vehicle where there is low pressure, contributing to the overall energy recapture by utilizing the highest possible pressure differentials between device input and device output.

Pursuant to an aspect, the present invention relates to wind-based generation of electrical energy in a towed trailer. By providing a venturi generator along the top front edge of the trailer with an inlet facing forward and an outlet facing laterally, electrical energy can be produced without increasing the aerodynamic drag of the trailer, effectively capturing energy that would otherwise be lost during towing of the trailer.

Pursuant to another aspect, the present invention relates to the combination of solar generation and wind-based generation of electrical energy in a towed trailer. By providing a venturi generator along the top front edge of the trailer with an inlet facing forward and an outlet facing laterally, electrical energy can be produced without increasing the aerodynamic drag of the trailer, effectively capturing energy that would otherwise be lost during towing of the trailer. Placing a solar collector on the flat top surface of the trailer, sufficiently close to the front of the trailer keeps the solar collector from being exposed to oncoming wind thereby avoiding wind-related losses resulting from inclusion of the solar collector.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

While the claims are not limited to a specific illustration, an appreciation of the various aspects is best gained through a discussion of various examples thereof. Although the drawings represent illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows.

FIG. 1 is a perspective and partial cutaway view of a wind generation system according to a preferred embodiment of the invention;

FIG. 2 is an illustration of a venturi having a ventilation port;

FIG. 3 is an illustration of an embodiment of the invention suitable for mounting at the desired location on a towed trailer;

FIG. 4A is a diagram of circuitry suitable for use in connection with the solar generator feature of the invention according to a first architecture; and

FIG. 4B is a diagram of circuitry suitable for use in connection with the solar generator feature of the invention according to a second architecture.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

According to an aspect, the disclosure relates to improving the recapture of energy lost to aerodynamic drag during towing of the trailer.

According to a further aspect, the disclosure relates to improving the recapture of energy lost to aerodynamic drag during towing of the trailer while simultaneously providing ventilation of the cargo space to avoid condensation, mold and mildew.

According to yet another aspect, the disclosure relates to improving the recapture of energy lost to aerodynamic drag during towing of the trailer while also capturing solar energy.

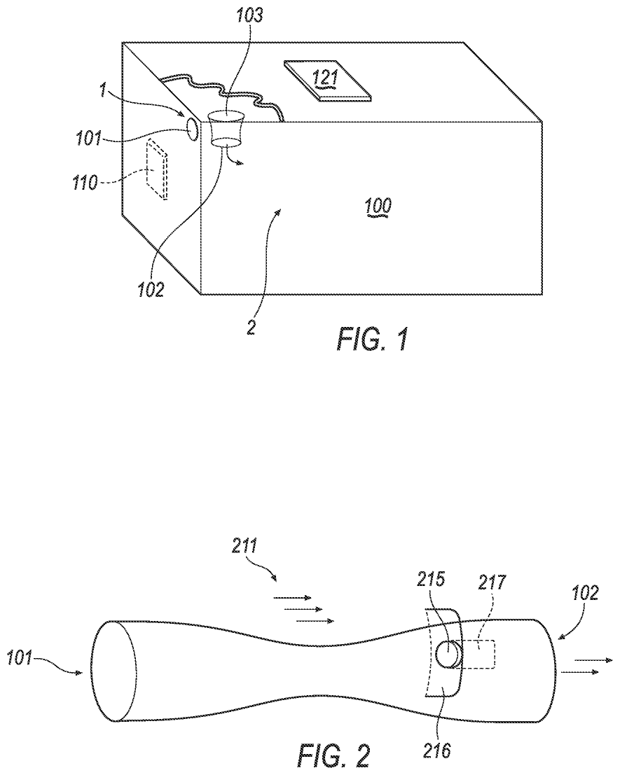

Referring to FIG. 1, the trailer 100 has a venturi generator 103 with an entrance 101 located on the front surface 1 of trailer 100. The venturi generator 103 of suitable design has an outlet 102 on side 2 of the trailer. The forward facing top corner of the trailer where entrance 101 is located is a particularly high pressure area on the front of the trailer since this corner is exposed to the onrushing air as the trailer travels along the road. Outlet 102 located on the upper side corner of the trailer several inches down from the top of the trailer is a low pressure area on the trailer caused by the deflection of air resulting from the front surface 1 facing oncoming air causing the air to have a significant lateral component moving away from the side two of the trailer near the location of venturi outlet 102. This lateral flow effectively pulls a low pressure condition just behind the front edge of the trailer. The close proximity of inlet 101 and outlet 102 permits employment of a compact venturi generator.

As illustrated in FIG. 2, the venturi can serve an incremental benefit associated with improving the utility of the trailer when used for long haul delivery purposes. By providing an orifice 215 on the side of the venturi channel to permit air from the interior of the trailer to enter this low pressure portion of the venturi it is possible to ventilate the interior of the trailer. This ventilation is accomplished by pulling air from the trailer interior into the venturi output channel section and venting it outside of the trailer. This is particularly important when the trailer is being hauled long distances from an area for instance with hot humid weather into an area with cooler weather. Absent ventilation within the trailer it is to be expected that condensation will occur and that the possibility of mold and mildew within the trailer could be damaging to the contents of the trailer. To improve the efficiency of the ventilation function introduced by orifice 215 in the venturi channel a directing flange 216 is located on the exterior of the venturi channel and then interior tube 217 will aid in improving the draw of air from the interior of the trailer to the outlet orifice 102 of the venturi generator 103.

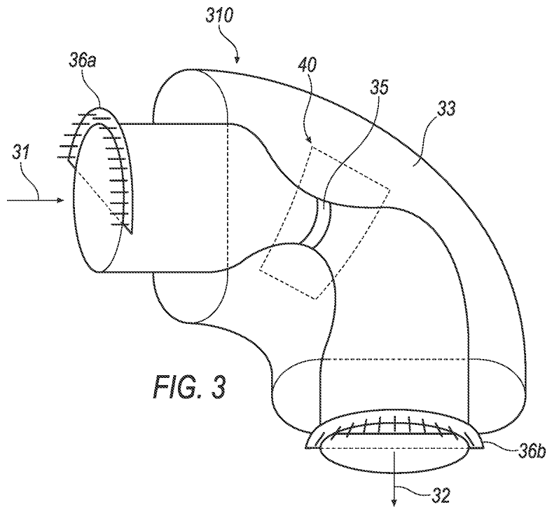

FIG. 3 illustrates a compact venturi generator design having forward facing inlet 31 with an access parallel to the direction of movement of the trailer and then outlet 32 perpendicular to the direction of movement of the trailer and preferably horizontal facing outward on the side of the trailer shrouds 36a and 36b provide protection from water flow due to rain or snow and are located external to the entrances entrance and exit 31 and 32 so as not to obstruct air flow. The venturi region 35 includes the generator component of the venture a generator 40.

The compact venturi structure 310 can be mounted as a single unit in the inside upper corner of the trailer where it has minimal interference with the loading and capacity of the trailer and where it has optimum aerodynamic efficiency. By having the inlet portion, outlet portion and generator unit all contained in a single housing 33 it is possible to have a very compact and easy to install unit. Electricity generated by the venturi generator is provided to battery unit 110 illustrated in FIG. 1.

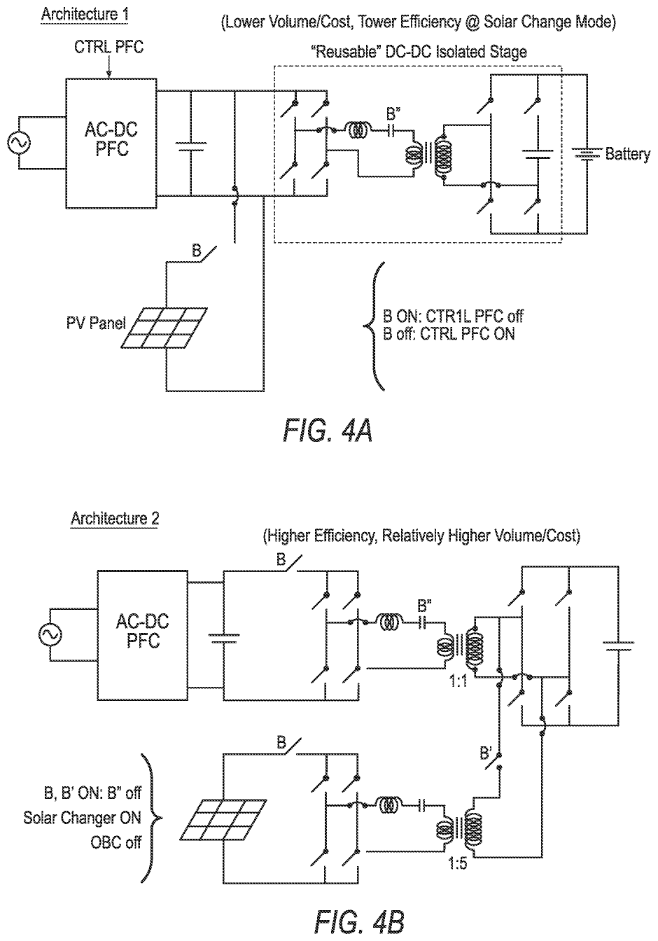

In addition to the venturi generator, it is proposed to include a coordinated solar generator 121 on the top surface of the trailer. This will provide incremental electrical energy to battery system 110, even when the vehicle is not underway. The addition of an additional source of electricity presents a challenge for an isolated unit such as a trailer. There is not necessarily any standing source of electricity other than the batteries 110 so there is no standard to which the energy outputs of the separate sources can be tied. FIG. 4 illustrates an efficient circuit for combining the output from the solar generator with the remainder of the system. Typically there would be a need for separately housing a solar charger, and providing an entire electrical system for receiving the solar power and conforming it to the system. According to this aspect of the invention, there is a potential to reuse and reconfigure the onboard charger power stage with a different modulation & control to make it replicate the solar charger functionality. All that is needed are two power relays (circuit breakers) to make or break the connection.

Either of the circuits illustrated in FIG. 4 can be used for introducing the solar power into the trailer's electrical system. Both the solutions shown in FIG. 4 are better in terms of volume/cost savings compared to the conventional solution of having separate units for OBC and solar charger.

Accordingly, pursuant to a first aspect of the disclosure, there is provided a venturi generator unit for installation in a commercial trailer of the type having a cargo hold. The venturi generator includes an inlet with an inlet axis and an outlet with an outlet axis, said inlet axis being oriented transversely (e.g., 90 degrees or perpendicular) to said outlet axis. A housing is adapted for mounting the inlet to a forward facing surface of said trailer and for mounting the outlet to a side facing surface of said trailer. By providing a venturi generator along the top front edge of the trailer with an inlet facing forward and an outlet facing laterally, electrical energy can be produced without increasing the aerodynamic drag of the trailer, effectively capturing energy that would otherwise be lost during towing of the trailer.

Pursuant to an implementation, the venturi generator unit has a venturi region and an outlet channel downstream from said venturi region, where the outlet channel has a port for venting air from within said trailer through said outlet.

Pursuant to a further implementation, a solar generator or solar collector is disposed on a flat top surface of the commercial trailer. The solar generator may be electrically connected to an electrical system of the trailer.

Pursuant to a second aspect of the disclosure, there is provided an electric regeneration unit for a towed trailer. The electric regeneration unit includes a venturi generator comprising an inlet with an inlet axis and an outlet with an outlet axis, the inlet axis extending transversely to the outlet axis. A housing contains the venturi generator, the housing structured and arranged to mount the inlet of the venturi generator to a forward facing surface of the trailer and the outlet of the venturi generator to a side facing surface of the trailer. A solar generator disposed on a top surface of the trailer. By providing a venturi generator along the top front edge of the trailer with an inlet facing forward and an outlet facing laterally, electrical energy can be produced without increasing the aerodynamic drag of the trailer, effectively capturing energy that would otherwise be lost during towing of the trailer. Placing a solar collector on the flat top surface of the trailer, sufficiently close to the front of the trailer keeps the solar collector from being exposed to oncoming wind thereby avoiding wind-related losses resulting from inclusion of the solar collector.

Pursuant to an implementation, the inlet axis is oriented 90 degrees from the outlet axis.

Pursuant to an implementation, the venturi generator has a venturi region and an outlet channel downstream from said venturi region, where the outlet channel has a port for venting air from within said trailer through said outlet.

Pursuant to an implementation, an output of the solar generator is electrically connected to an electrical system of the trailer. Optionally, the solar generator is electrically connected with an onboard charger of the towed trailer.

Pursuant to a further aspect of the disclosure, there is provided a towed trailer comprising such an electric regeneration unit.

While the invention has been described with respect to several specific implementations, it is to be understood that the innovation includes many other possible implementations based on the inventive concepts as described herein.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

What is claimed is:

1. A venturi generator unit for installation in a commercial trailer of the type having a cargo hold, comprising:
an inlet with an inlet axis and an outlet with an outlet axis, said inlet axis being oriented 90 degrees from said outlet axis; and
a housing adapted for mounting the inlet to a forward facing surface of said trailer and for mounting the outlet to a side facing surface of said trailer.

2. The venturi generator unit of claim 1, further comprising a venturi region and an outlet channel downstream from said venturi region, said outlet channel having a port for venting air from within said trailer through said outlet.

3. The venturi generator unit of claim 1, further comprising a solar generator disposed on a flat top surface of the commercial trailer.

4. An electric regeneration unit for a towed trailer, comprising:
a venturi generator unit comprising an inlet with an inlet axis and an outlet with an outlet axis, the inlet axis extending transversely to the outlet axis;
a housing containing the venturi generator unit, structured and arranged to mount the inlet to a forward facing surface of said trailer and the outlet to a side facing surface of said trailer; and
a solar generator disposed on a top surface of the trailer.

5. The electric regeneration unit of claim 4, wherein the inlet axis is oriented 90 degrees from the outlet axis.

6. The electric regeneration unit of claim 4, wherein the venturi generator unit has a venturi region and an outlet channel downstream from said venturi region, said outlet channel having a port for venting air from within said trailer through said outlet.

7. The electric regeneration unit of claim 4, wherein an output of the solar generator is electrically connected with an onboard charger of the towed trailer.

8. A vehicle trailer, comprising an electric regeneration unit as claimed in claim 4.
